(19) United States
(12) Patent Application Publication
(10) Pub. No.: US 2006/0200543 A1
(43) Pub. Date: Sep. 7, 2006

(54) Method and apparatus for tightly coupled interworking between cellular network and WLAN network

(75) Inventors: Dong-Keon Kong, Suwon-si (KR); Sang-Jun Moon, Yongin-si (KR); Ji-Cheol Lee, Yongin-si (KR); Dae-Seok Kim, Seoul (KR); Sang-Do Lee, Suwon-si (KR); Heung-Chul Jung, Suwon-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics. Co. Ltd.

(21) Appl. No.: 11/367,308

(22) Filed: Mar. 6, 2006

(30) Foreign Application Priority Data
Mar. 4, 2005 (KR) 2005-18073

(51) Int. Cl. G06F 15/173

(52) U.S. Cl. 709/223

(57) ABSTRACT

When a terminal moves from a WLAN network to a cellular network after being allocated an IP address from a PDSN of the cellular network, a tightly coupled interworking method and apparatus between the cellular network and the WLAN network set up a temporary tunnel between the PDSN and an AGW of the WLAN network, and after completion of the handoff from the WLAN network to the cellular network, inform the PDSN of the handoff completion from the terminal, thereby enabling fast seamless handoff without data loss. Compared with the conventional tightly coupled scheme, the proposed tightly coupled scheme can prevent the need for processing cellular signals in the WLAN network because there is no need to transmit cellular signals in a WLAN interval, especially between the terminal and the AGW.

### CROSS-REFERENCE TO RELATED APPLICATION

This application claims the benefit under 35 U.S.C. § 119(a) of a Korean patent application entitled “Method and Apparatus for Tightly Coupled Interworking between Cellular Network and WLAN Network” filed in the Korean Intellectual Property Office on Mar. 4, 2005 and assigned Serial No. 2005-18073, the entire contents of which are hereby incorporated by reference.

### BACKGROUND OF THE INVENTION

1. Field of the Invention

The present invention relates to an interworking method and apparatus between heterogeneous networks. In particular, the present invention relates to a tightly coupled interworking method and apparatus for allowing a terminal to perform handoff to a Wireless Local Area Network (WLAN) network without a change in cellular network element in an interworking scheme that uses a cellular network and a WLAN network.

2. Description of the Related Art

Recently, with the activation of WLAN service, the issue of service interworking between a 3^{rd} Generation (3G) cellular network and a WLAN network is now attracting attention. During vertical handoff between two heterogeneous networks, a handoff time and a packet loss caused by the handoff are very important factors. Accordingly, there is a need for an efficient interworking scheme capable of minimizing the handoff time and the packet loss. In addition, the required change in the existing system and terminal needed for interworking between the heterogeneous networks should be minimized.

Currently, 3^{rd} Generation Partnership Project (3GPP) proposes a tightly coupled scheme that regards a WLAN network as an access network for a Universal Mobile Telecommunication System (UMTS) 3G system.

FIG. 1 is a diagram illustrating configuration of a UMTS network and a WLAN network based on a conventional tightly coupled scheme.

Referring to FIG. 1, the tightly coupled scheme has a configuration in which a WLAN network 130 is coupled to a UMTS core network 100. The WLAN network 130 serves as an access network like an UMTS Radio Access Network (UTRAN) 110. Each subscriber uses UMTS service via the UTRAN 110 or the WLAN network 130 through access points (APs) 132 and 134 according to network access environment.

An Interworking Unit (IWU) 120 is equipment provided for interworking between the UMTS core network 100 and the WLAN network 130, and its basic service control and management function is controlled by the UMTS core network 100.

The conventional tightly coupled interworking scheme described above can support the same mobility, Quality of Service (QoS) and security functions as those provided in the existing UMTS network. However, in order to support these functions, a WLAN terminal 140 must have a built-in UMTS module, and an additional standardization work is needed for interfaces.

### SUMMARY OF THE INVENTION

Therefore, an object of the present invention is to provide an interworking method and apparatus between an asynchronous mobile communication network and a Wireless Local Area Network (WLAN) network based on a tightly coupled scheme.

Another object of the present invention is to provide a method and apparatus for providing seamless handoff even in the case where a terminal not supporting Mobile IP has moved from a cellular network to a WLAN network.

According to one aspect of the present invention, a method for forming a Layer 3 access point for tightly coupled interworking between a cellular network and a wireless local area network (WLAN) network is provided. The method comprises transmitting, by a terminal which searches and selects the WLAN network while communicating with the cellular network, a Dynamic Host Configuration Protocol (DHCP) Discover message used for requesting allocation of an Internet Protocol (IP) address, receiving, by an access gateway (AGW) of the WLAN network, the DHCP Discover message from the terminal, setting up a Generic Routing Encapsulation (GRE) tunnel to a packet data serving network (PDSN) of the cellular network, and delivering the DHCP Discover message to the PDSN through the GRE tunnel, receiving, by the AGW, a DHCP Offer message including IP addresses allocable to the terminal from the PDSN, and delivering the received DHCP Offer message to the terminal, transmitting, by the terminal, a DHCP Request message requesting an IP address, and delivering, by the AGW, the DHCP Request message to the PDSN through the GRE tunnel, receiving, by the AGW, a DHCP ACK message from the PDSN in response to the DHCP Request message, and delivering the DHCP ACK message to the terminal, and receiving by the terminal, the DHCP ACK message.

According to another aspect of the present invention, a handoff method in a tightly coupled interworking network between a 3_{rd} generation (3G) cellular network and a wireless local area network (WLAN) network is provided. The method comprises transmitting, by a terminal, a Dynamic Host Configuration Protocol (DHCP) Inform message used for requesting setup of a tunnel to a packet data serving network (PDSN) of the cellular network, receiving, by an access gateway (AGW) of the WLAN network, the DHCP Inform message, setting up a temporary tunnel to the PDSN, generating a DHCP ACK message indicating the setup result of the temporary tunnel, and delivering the DHCP ACK message to a terminal, transmitting, by the terminal, a DHCP Inform message indicating completion of handoff from the cellular network to the WLAN network, receiving, by the AGW, the DHCP Inform message, and setting up a regular tunnel to the PDSN, and receiving, by the terminal, a DHCP ACK message indicating the setup result of the regular tunnel.

According to further another aspect of the present invention, an apparatus for tightly coupled interworking between a cellular network and a wireless local area network (WLAN) network is provided. The apparatus comprises a terminal connected thereto through the cellular network or the WLAN network, a packet data serving network (PDSN) for allocating an Internet Protocol (IP) address to the terminal, and transmitting packet data of the terminal to an IP network, an access point (AP) for processing a WLAN access standard with a terminal connected to the WLAN network, an access gateway (AGW) for receiving a message used for requesting allocation of an IP address from a terminal which searches and selects the AP of the WLAN network while communicating with the cellular network, receiving an IP address allocated from the PDSN for the terminal, and delivering the allocated IP address to the terminal.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating configuration of a UMTS network and a WLAN network based on a conventional tightly coupled scheme;

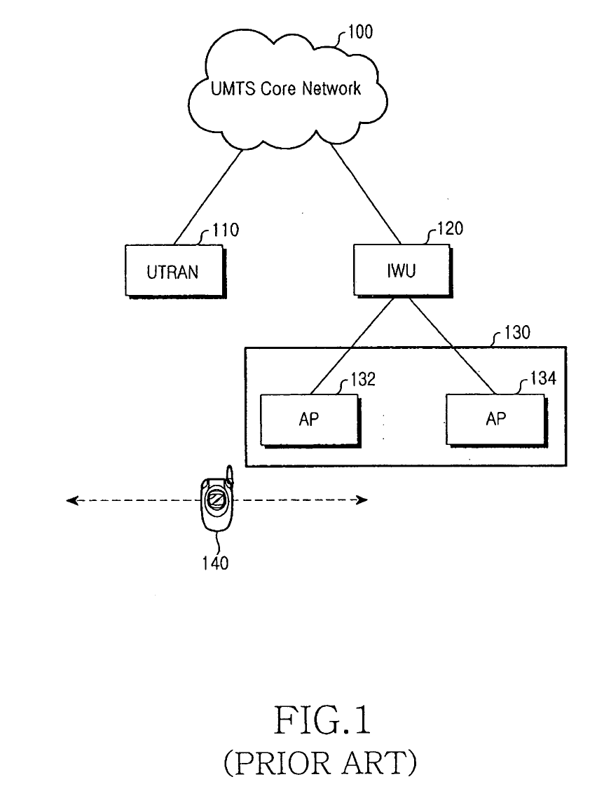

FIG. 2 is a diagram illustrating a configuration of a tightly coupled interworking network between a cellular network and a WLAN network according to an exemplary embodiment of the present invention;

FIG. 3 is a diagram illustrating a signaling plan according to an exemplary embodiment of the present invention;

FIG. 4 is a diagram illustrating a traffic plan according to an exemplary embodiment of the present invention;

FIG. 5 is a ladder diagram illustrating a Layer 3 access point setup procedure performed between a terminal and a PDSN in a tightly coupled interworking network in which the terminal accesses a WLAN network, according to an exemplary embodiment of the present invention;

FIG. 6 is a ladder diagram illustrating a handoff procedure of a terminal in an interworking scenario between a cellular network and a WLAN network according to an exemplary embodiment of the present invention;

FIG. 7 is a diagram illustrating a format of a DHCP message according to an exemplary embodiment of the present invention;

FIG. 8 is a diagram illustrating a table showing an ‘AT Identifier’ option according to an exemplary embodiment of the present invention;

FIG. 9 is a diagram illustrating a table showing an ‘A-P tunnel request’ option according to an exemplary embodiment of the present invention; and

FIG. 10 is a diagram illustrating a table showing an ‘A-P tunnel response’ option according to an exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the accompanying drawings. In the following description, a detailed description of known functions and configurations incorporated herein has been omitted for clarity and conciseness.

According to an exemplary embodiment of the present invention, a Code Division Multiple Access (CDMA) 2000 1X system may serve as a cellular network and an IEEE 802.11x-based Wireless-Fidelity (WiFi) network may serve as a WLAN network.

Specifically, an implementation of the present invention provides a configuration of a tightly coupled interworking scheme for allowing a terminal to efficiently perform handoff from a cellular network to a WLAN network, protocol stacks of the terminal and system, a Layer 3 access point setup process performed between the terminal and an Access Gateway (AGW), and a handoff signal processing method in the terminal, the AGW and a Packet Data Serving Network (PDSN) when the terminal accessing the cellular network has moved to the WLAN network.

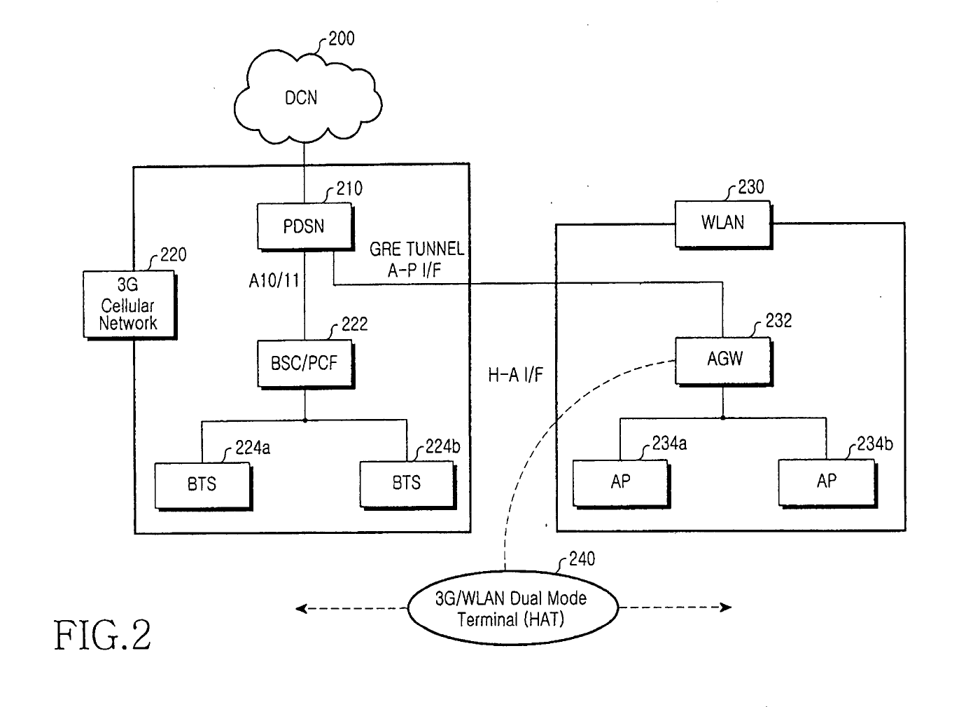

FIG. 2 is a diagram illustrating a configuration of a tightly coupled interworking network between a cellular network and a WLAN network according to an exemplary embodiment of the present invention.

Referring to FIG. 2, in a tightly coupled interworking network according to an exemplary embodiment of the present invention, a WLAN network 230 is classified as an access network for a cellular network 220.

A cellular network 220 comprises a PDSN 210 and a Base Station System (BSS). The PDSN 210 provides an accounting and authentication function, a Point-to-Point Protocol (PPP) connection function, an Internet Protocol (IP) routing function, and a vertical handoff function to a terminal that accesses an IP network via a cellular network, which is connected to a data communication network (DCN) 200, and serves as a Foreign Agent (FA) when it supports Mobile IP. The BSS comprises Base Transceiver Stations (BTSs) 224a and 224b, which are equipments for processing a wireless access standard with a terminal accessing the cellular network, and a Base Station Controller (BSC) 222. The BSC 222 comprises a Packet Control Function (PCF).

The WLAN network 230 comprises an AGW 232 and Access Points (APs) 234a and 234b. The AGW 232 delivers packet data received from a terminal, to a user accessing the PDSN 210 via the WLAN network 230, in a direction of the PDSN 210 via a Generic Routing Encapsulation (GRE) tunnel, or in the opposite direction, and a Hybrid Access Terminal (HAT) 240 is a terminal capable of accessing both the WLAN network 230 and the cellular network 220. The GRE tunnel is established between the PDSN 210 and the AGW 232.

The AGW 232 is located between the PDSN 210 of the cellular network 220 and the APs 234a and 234b of the WLAN network 230, and an A-P interface being similar to the existing R-P interface between the BSC 222 and the PDSN 210 of the cellular network is defined. In addition, an H-A interface is defined between the HAT 240 and the AGW 232, and a Dynamic Host Configuration Protocol (DHCP) is used therefor.

With reference to FIGS. 2 through 4, a signaling plan and a traffic plan operating in an interworking network will be described according to an exemplary embodiment of the present invention.

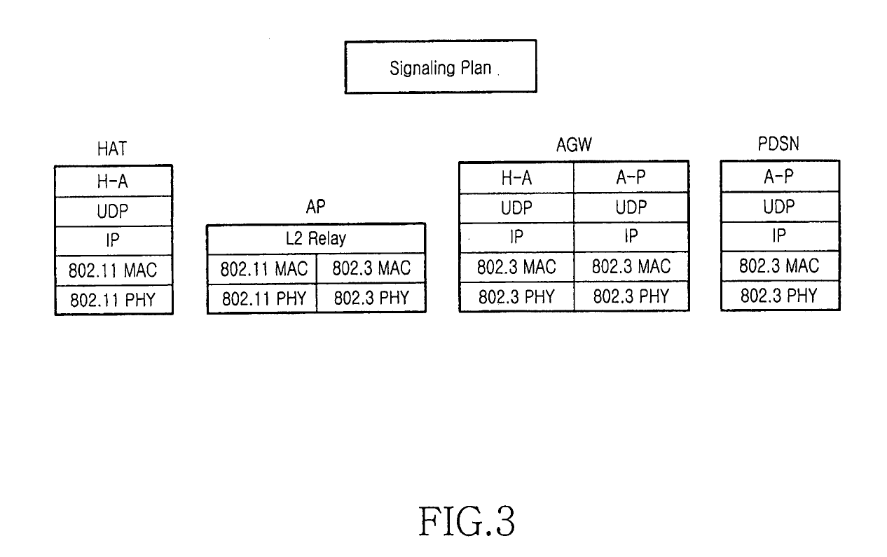

FIG. 3 is a diagram illustrating a signaling plan according to an exemplary embodiment of the present invention.

Referring to FIG. 3, an H-A interface between an HAT 240 and an AGW 232 transmits an H-A handoff signal. A protocol stack of the HAT 240, for transmitting the H-A handoff signal, comprises 802.11 PHY, 802.11 MAC, IP, UDP, and H-A.

Next, protocol stacks for setting up a Layer 3 access point are set up in APs 234a and 234b, an AGW 232, and a PDSN 210. Protocol stacks of the APs 234a and 234b comprise 802.11 PHY, 802.11 MAC, 802.3 PHY, 802.3 MAC, and L2 Relay. A protocol stack of the PDSN 210 includes 802.3 PHY, 802.3 MAC, IP, UDP, and A-P. A protocol stack of the AGW 232 has an H-A interface for interfacing with the HAT 240 and an A-P interface for interfacing with the PDSN 210, and a Layer 3 access point is set up between the HAT 240 and the PDSN 210.

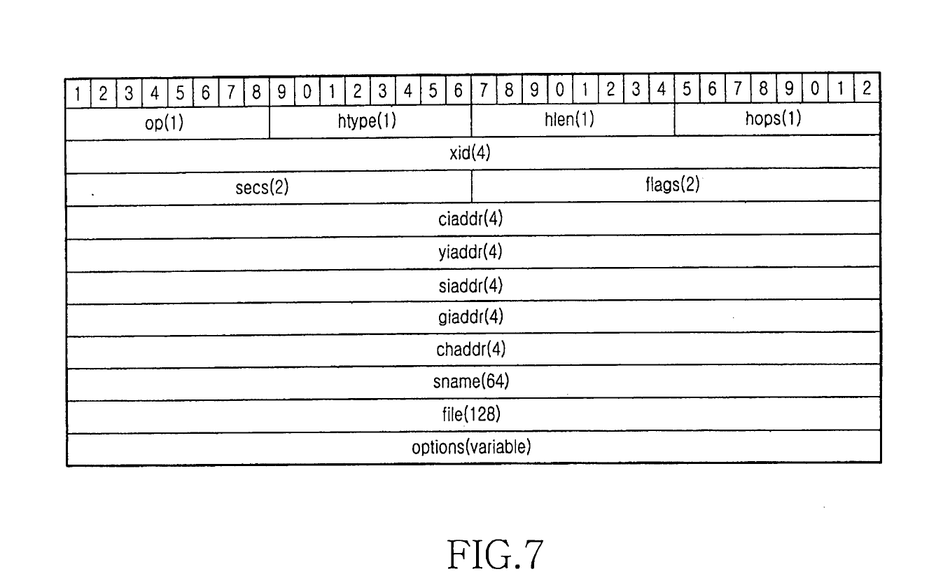

The foregoing protocol stacks use 802.3 MAC and 802.3 PHY for a Medium Access Control (MAC) layer and a Physical (PHY) layer, respectively, and use a User Datagram Protocol (UDP) as a transport protocol. In addition, the protocol tacks use the H-A for interfacing between the AGW 232 and the HAT 240 and the A-P for interfacing between the AGW 232 and the PDSN 210. Further, the protocol stacks use a DHCP as an upper protocol, and newly define a DHCP option field. The DHCP option field comprises parameters for Layer 3 access, and a detailed description thereof will be made later with reference to FIGS. 7 through 10.

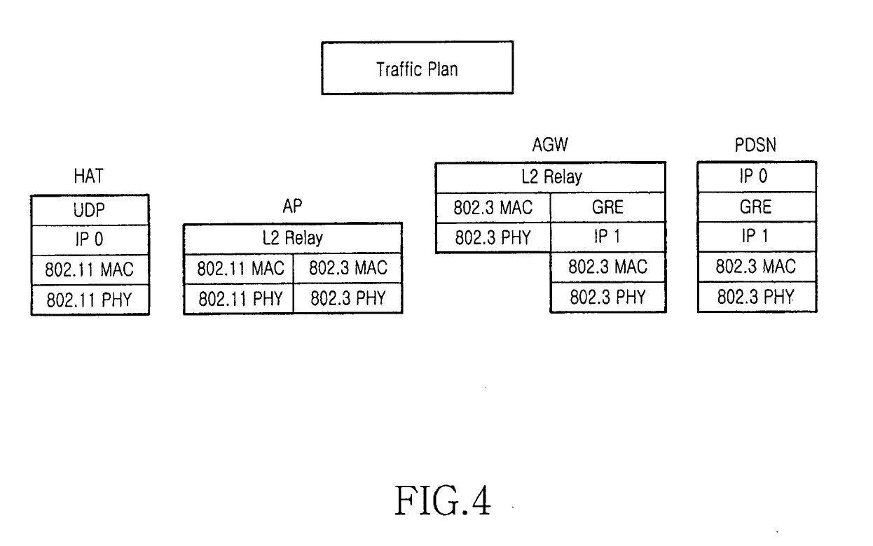

FIG. 4 is a diagram illustrating a traffic plan according to an exemplary embodiment of the present invention.

Referring to FIG. 4, a protocol stack of an HAT 240, for an H-A interface, comprises 802.11 PHY, 802.11 MAC, IP 0, and UDP, and protocol stacks of APs 234a and 234b, for the H-A interface, are equal to those used in the signaling plane shown in FIG. 3. A protocol stack of a PDSN 210 comprises 802.3 PHY, 802.3 MAC, IP 1, GRE, and IP 0.

A protocol stack of an AGW 232 comprises the same structure as that of the protocol stack of the PDSN 210, for an access to the PDSN 210, and further includes 802.3 PHY, 802.3 MAC, and L2 relay, for an access to the APs 234a and 234b.

Upon receiving traffics from the HAT 240 through the protocol stacks for traffic transmission, the AGW 232 delivers the received traffics to the PDSN 210 through a GRE tunnel. The forward traffics transmitted from a counterpart host to the HAT 240 are forwarded to the AGW 232 through a GRE tunnel between the PDSN 210 and the AGW 232.

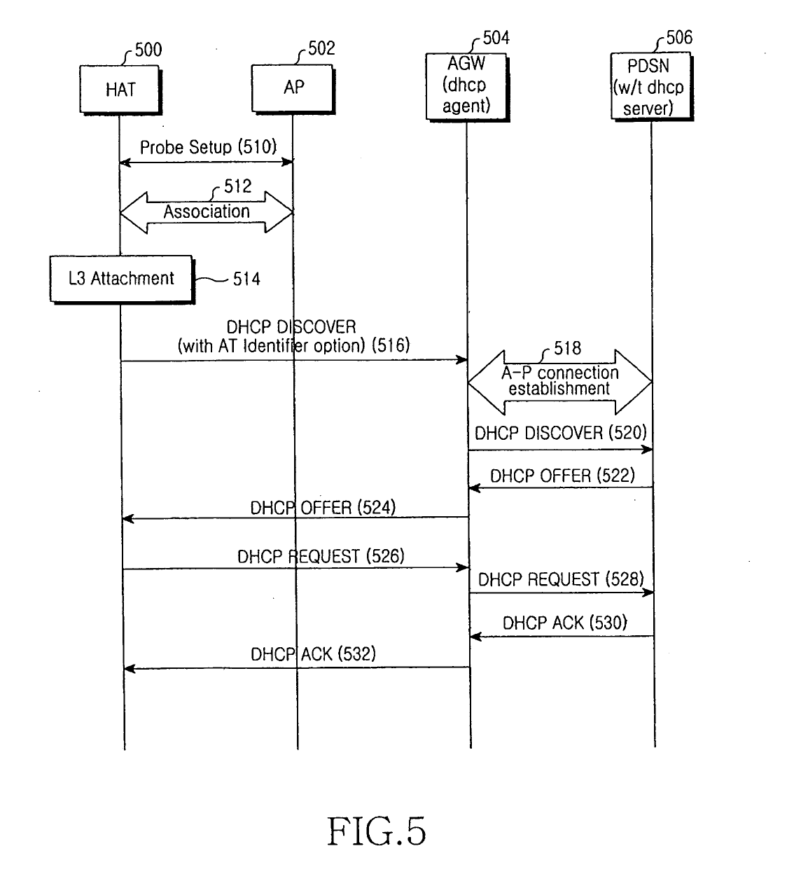

FIG. 5 is a ladder diagram illustrating a Layer 3 access point setup procedure performed between a terminal and a PDSN in a tightly coupled interworking network in which the terminal accesses a WLAN network, according to an exemplary embodiment of the present invention.

Referring to FIG. 5, if an HAT 500 searches for and selects an AP 502 of a WLAN network in step 510 while communicating with a cellular network, the HAT 500 sets up association between the HAT 500 and the AP 502 in step 512.

The HAT 500 performs Layer 3 (L3) Attachment in step 514, and generates in step 516 a DHCP DISCOVER message used for searching for a DHCP server and delivers the DHCP DISCOVER message to an AGW 504 via the AP 502 that performs a DHCP relay function, for the purpose of requesting IP address allocation. Herein, the DHCP DISCOVER message comprises an ‘AT Identifier’ option which is ID information of the HAT 500, and a MAC address of the HAT 500.

Thereafter, the AGW 504 can be aware that the HAT 500 uses the tightly coupled interworking scheme based on the ID information included in the DHCP DISCOVER message received from the HAT 500. Therefore, the AGW 504 personally delays the DHCP DISCOVER message to a PDSN 506 instead of allocating an IP address to the HAT 500. That is, the AGW 504 sets up an A-P connection, in other words, a GRE tunnel, to a default PDSN 506 in step 518. In this case, the AGW 504 adds the HAT 500 to an A-P session table as an entry based on a MAC address of the HAT 500, acquired from the received DHCP DISCOVER message, and the PDSN 506 adds an entry to an R-P session table based on an ID of the HAT 500. Thereafter, the AGW 504 delivers the DHCP DISCOVER message to the PDSN 506 through the GRE tunnel in step 520.

Upon receiving the DHCP DISCOVER message through the GRE tunnel, the PDSN 506 maps the MAC address of the HAT 500 to the ID value in the A-P session table. In step 522, the PDSN 506 generates a DHCP OFFER message including an IP address allocable to the HAT 500 and necessary information, and delivers the DHCP OFFER message to the AGW 504.

In step 524, the AGW 504 forwards the DHCP OFFER message received from the PDSN 506, to the HAT 500 via the A-P interface.

Upon receiving the DHCP OFFER message, the HAT 500 transmits a DHCP REQUEST message to the AGW 504 in step 526. The DHCP REQUEST message is a message used to request parameters provided from the DHCP server, determine whether an IP address previously allocated for later system rebooting is correct, or extend a use time for a particular IP address.

Upon receiving the DHCP REQUEST message, the AGW 504 delivers the DHCP REQUEST message through the GRE tunnel up to the PDSN 506 in step 528. Upon receiving the DHCP REQUEST message, the PDSN 506 delivers a DHCP ACK message to the AGW 504 through the GRE tunnel in step 530. The DHCP ACK message comprises configuration parameters including the IP address allocated to the terminal.

Upon receiving the DHCP ACK message through the GRE tunnel, the AGW 504 adds, thereto, routing information for the IP address allocated to the HAT 500 and a Proxy Address Resolution Protocol (ARP) entry and delivers the DHCP ACK message to the HAT 500 in step 532.

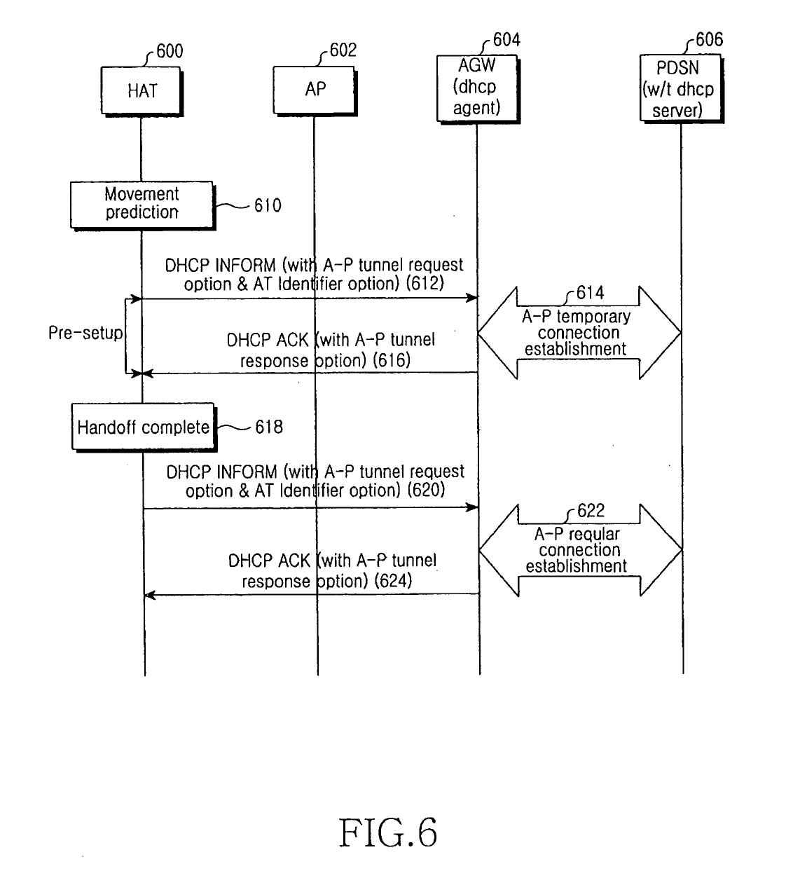

FIG. 6 is a ladder diagram illustrating a handoff procedure of a terminal in an interworking scenario between a cellular network and a WLAN network according to an exemplary embodiment of the present invention.

Referring to FIG. 6, if an HAT 600 determines to move from a 3G cellular area to a WLAN area in step 610, the HAT 600 generates in step 612 a DHCP INFORM message used for searching for an AGW 604 that supports vertical handoff from a 3G cellular network to a WLAN network, and transmits the generated DHCP INFORM message via an AP 602 on a broadcast basis. Herein, the DHCP INFORM message comprises an ‘AT Identifier’ option and an ‘A-P tunnel request’ option. The ‘A-P tunnel request’ option comprises information needed by the AGW 604 to set up an A-P tunnel. Specifically, the HAT 600 requests temporary A-P tunnel setup with a PDSN 606 by setting a TMP flag in the ‘A-P tunnel request’ option to ‘1’. The AP 602 supporting a DHCP relay function delivers the DHCP INFORM message generated by the HAT 600 to its neighbor AGWs.

Upon receiving the DHCP INFORM message including the ‘A-P tunnel request’ option, the AGW 604 adds, thereto, routing information for an IP address being used by the HAT 600 and sets up a temporary A-P tunnel to the PDSN 606 according to the ‘A-P tunnel request’ option, in step 614.

After successfully setting up the temporary A-P tunnel to the PDSN 606, the AGW 604 generates a DHCP ACK message and delivers the DHCP ACK message to the HAT 600 in step 616. In this case, the AGW 604 comprises an ‘A-P tunnel response’ option in the DHCP ACK message to inform the HAT 600 of the resultant tunnel temporarily set up between the AGW 604 and the PDSN 606.

After the temporary A-P tunnel is established between the AGW 604 and the PDSN 606, if the HAT 600 completes handoff from the 3G cellular area to the WLAN area in step 618, the HAT 600 generates a DHCP INFORM message for informing the H-A handoff completion and delivers the generated DHCP INFORM message to the AGW 604 in step 620. In this case, the HAT 600 sets a TMP flag in the ‘A-P tunnel request’ option to ‘0’, to request regular A-P tunnel setup to the PDSN 606.

Upon receiving the DHCP INFORM message indicating the H-A handoff completion, the AGW 604 analyzes the TMP flag and changes the temporary A-P tunnel to the PDSN 606 to a regular A-P tunnel in step 622. After completion of the A-P tunnel setup procedure to the AGW 604, the PDSN 606 releases an R-P tunnel to a BSC that performs PCF in the cellular network.

In step 624, the AGW 604 generates a DHCP ACK message and delivers the DHCP ACK message to the HAT 600. In this case, the AGW 604 comprises an ‘A-P tunnel response’ option in the DHCP ACK message before transmission, to inform the regular A-P tunnel setup.

FIG. 7 is a diagram illustrating a format of a DHCP message according to an exemplary embodiment of the present invention. Herein, the DHCP message comprises a DHCP DISCOVER message, a DHCP OFFER message, a DHCP REQUEST message, a DHCP INFORM message, and a DHCP ACK message.

Referring to FIG. 7, the other fields except for an ‘options’ field included in the DHCP message are substantially same as the general fields, so a description thereof will be omitted. The ‘options’ field comprises therein an ‘AT Identifier’ option containing AT Identifier information, an ‘A-P tunnel request’ option used for requesting or releasing setup of a temporary/regular A-P tunnel (meaning a GRE tunnel), and an ‘A-P tunnel response’ option containing the result for the A-P tunnel setup.

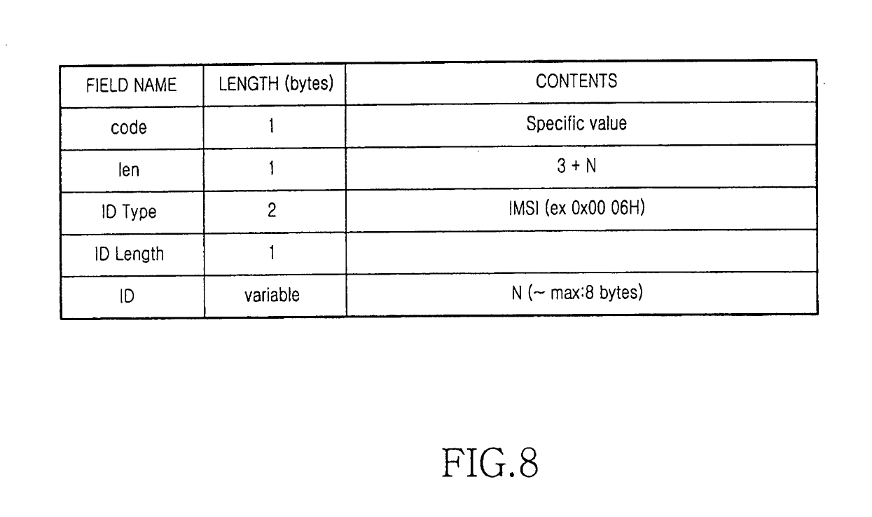

FIG. 8 is a diagram illustrating a table showing an ‘AT Identifier’ option according to an exemplary embodiment of the present invention.

Referring to FIG. 8, an IMSI option, which is the ‘AT Identifier’ option, comprises a code field, a len (length) field, an ID Type field, an ID Length field, and an ID field. The ID Type field can comprise therein ‘0x00 06H’ as an IMSI, and the ‘AT Identifier’ option can be included in a DHCP DISCOVER message generated by an AT, before being transmitted to an AGW.

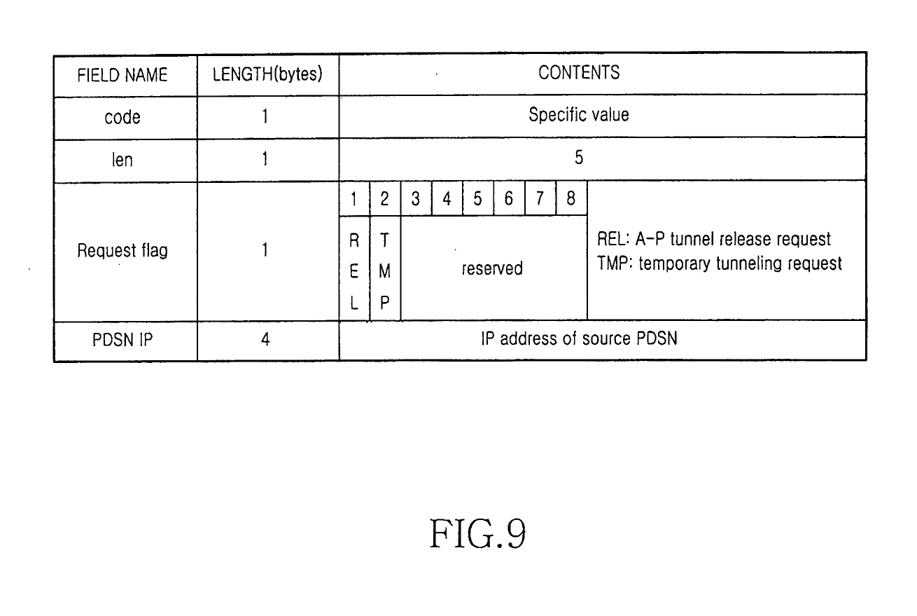

FIG. 9 is a diagram illustrating a table showing an ‘A-P tunnel request’ option according to an exemplary embodiment of the present invention.

Referring to FIG. 9, the ‘A-P tunnel request’ option comprises a code field, a len field, a request flag field, and a PDSN IP field. The request flag comprises an A-P tunnel release request (REL) flag used for releasing an A-P tunnel, and a temporary tunneling request (TMP) flag used for setting up an A-P tunnel. That is, if the REL flag is set to ‘1’, it requests release of a previously set up A-P tunnel, and if the TMP flag is set to ‘1’, it requests temporary A-P tunnel setup. In addition, after performing handoff to a WLAN network, a terminal can request setup of a regular A-P tunnel by setting the TMP flag to ‘0’. The PDSN IP field comprises therein a source PDSN IP address given before the terminal performs handoff to the WLAN network.

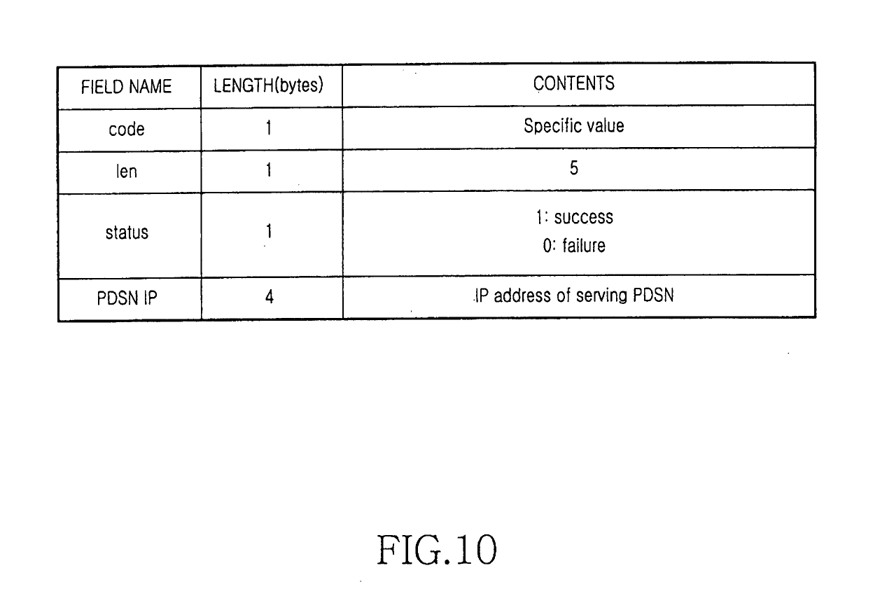

FIG. 10 is a diagram illustrating a table showing an ‘A-P tunnel response’ option according to an exemplary embodiment of the present invention.

Referring to FIG. 10, the ‘A-P tunnel response’ option comprises a code field, a len field, a status field, and a PDSN IP field. The status field is set to ‘1’ when a temporary or regular A-P tunnel is successfully set up, and the status field is set to ‘0’ when setup of the A-P tunnel is failed. The PDSN IP field comprises therein a serving PDSN IP address given after the terminal performs handoff to the WLAN network.

As can be understood from the foregoing description, the present invention provides a tightly coupled scheme for efficiently interworking a cellular network with a WLAN network. When a terminal moves from a WLAN network to a cellular network, the tightly coupled scheme previously sets up a temporary tunnel between a PDSN and an AGW of the WLAN network, and after completion of the handoff from the WLAN network to the cellular network, informs the PDSN of the handoff completion from the terminal, thereby enabling fast seamless handoff without data loss. In addition, compared with the conventional tightly coupled scheme, the proposed tightly coupled scheme can prevent the need for processing cellular signals in the WLAN network because there is no need to transmit cellular signals in a WLAN interval, especially between the terminal and the AGW.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for forming a Layer 3 access point for tightly coupled interworking between a cellular network and a wireless local area network (WLAN) network, the method comprises:
transmitting, by a terminal which searches and selects the WLAN network while communicating with the cellular network, a Dynamic Host Configuration Protocol (DHCP) Discover message used for requesting allocation of an Internet Protocol (IP) address;
receiving, by an access gateway (AGW) of the WLAN network, the DHCP Discover message from the terminal, and setting up a Generic Routing Encapsulation (GRE) tunnel to a packet data serving network (PDSN) of the cellular network; delivering the DHCP Discover message to the PDSN through the GRE tunnel;
receiving, by the AGW, a DHCP Offer message having IP addresses allocable to the terminal from the PDSN, and delivering the received DHCP Offer message to the terminal;
transmitting, by the terminal, a DHCP Request message requesting an IP address, and delivering, by the AGW, the DHCP Request message to the PDSN through the GRE tunnel;
receiving, by the AGW, a DHCP ACK message from the PDSN in response to the DHCP Request message, and delivering the DHCP ACK message to the terminal; and
receiving, by the terminal, the DHCP ACK message.

2. The method of claim 1, wherein the DHCP message comprises therein identifier information of the terminal;
wherein the AGW delivers the DHCP Discover message to the PDSN, determining from the identifier information of the terminal that the terminal uses the tightly coupled interworking scheme.

3. The method of claim 1, wherein, to set up a GRE tunnel in the step of receiving a DHCP Discover message, the AGW adds the terminal to an R-P session table as an entry based on a Medium Access Control (MAC) address of the terminal, acquired from the received DHCP Discover message, and the PDSN adds the terminal to the R-P session table as an entry based on identifier information of the terminal, acquired from the received DHCP Discover message.

4. A handoff method in a tightly coupled interworking network between a 3^{rd} generation (3G) cellular network and a wireless local area network (WLAN) network, the method comprises:
transmitting, by a terminal, a Dynamic Host Configuration Protocol (DHCP) Inform message used for requesting setup of a tunnel to a packet data serving network (PDSN) of the cellular network;
receiving, by an access gateway (AGW) of the WLAN network, the DHCP Inform message; setting up a temporary tunnel to the PDSN, generating a DHCP ACK message indicating the setup result of the temporary tunnel, and delivering the DHCP ACK message to a terminal;
transmitting, by the terminal, a DHCP Inform message indicating completion of handoff from the cellular network to the WLAN network;
receiving, by the AGW, the DHCP Inform message, and setting up a regular tunnel to the PDSN; and
receiving, by the terminal, a DHCP ACK message indicating the setup result of the regular tunnel.

5. The handoff method of claim 4, wherein the DHCP Inform message comprises identifier information of the terminal and information for the tunnel setup.

6. The handoff method of claim 5, wherein the identifier information of the terminal comprises ID information of the terminal, code information, length information, ID type information, and ID length information.

7. The handoff method of claim 5, wherein the information for the tunnel setup comprises a flag used for setting up or releasing the tunnel, and an Internet Protocol (IP) address of the PDSN connected to the terminal.

8. The handoff method of claim 4, further comprising releasing, by the PDSN, the tunnel connected to a base station system of the cellular network, after the setting up a regular tunnel.

9. The handoff method of claim 4, wherein the DHCP ACK message comprises information indicating whether the temporary tunnel or the regular tunnel is successfully set up, and an IP address of the PDSN connected to the terminal.

10. An apparatus for tightly coupled interworking between a cellular network and a wireless local area network (WLAN) network, comprising:
a terminal connected thereto through the cellular network or the WLAN network;
a packet data serving network (PDSN) for allocating an Internet Protocol (IP) address to the terminal, and transmitting packet data of the terminal to an IP network;
an access point (AP) for processing a WLAN access standard with a terminal connected to the WLAN network; and
an access gateway (AGW) for receiving a message used for requesting allocation of an IP address from a terminal which searches and selects the AP of the WLAN network while communicating with the cellular network, receiving an IP address allocated from the PDSN for the terminal, and delivering the allocated IP address to the terminal.

11. The apparatus of claim 10, wherein the AGW comprises an H-A interface for interfacing with the terminal, and an A-P interface for interfacing with the PDSN;
wherein a Layer 3 access point between the AP and the PDSN is set up through the AGW.

12. The apparatus of claim 10, wherein the terminal transmits a Dynamic Host Configuration Protocol (DHCP) Discover message which used for requesting allocation of the IP address and comprises identifier information of the terminal.

13. The apparatus of claim 12, wherein the AGW receives from the terminal the DHCP Discover message, analyzes identifier information of the terminal included in the received DHCP Discover message thereby to set up a Generic Routing Encapsulation (GRE) tunnel to the PDSN, delivers the DHCP Discover message to the PDSN through the GRE tunnel, receives an allocated IP address for the terminal from the PDSN through the GRE tunnel, and delivers the allocated IP address to the terminal.

14. The apparatus of claim 10, wherein when a terminal located in the cellular network desires to move to the WLAN network, the terminal transmits a DHCP Inform message which used for requesting setup of a temporary tunnel to the PDSN and comprises identifier information of the terminal and information for the tunnel setup.

15. The apparatus of claim 14, the AGW receives from the terminal the DHCP Inform message and sets up a temporary tunnel to the PDSN.

16. The apparatus of claim 15, wherein after setting up a temporary tunnel to the PDSN, the terminal transmits a DHCP Inform message which used for requesting setup of a regular tunnel to the PDSN and comprises identifier information of the terminal and information for the tunnel setup.

17. The apparatus of claim 16, the AGW receives the DHCP Inform message from the terminal that performed handoff to the WLAN network thereby to set up a regular tunnel to the PDSN, and exchanges packet data with the terminal through the regular tunnel.

18. A method for allocating of an Internet Protocol (IP) address to a terminal for tightly coupled interworking between a cellular network and a wireless local area network (WLAN) network, the method comprises:
transmitting, by a terminal which searches and selects the WLAN network while communicating with the cellular network, a Dynamic Host Configuration Protocol (DHCP) Discover message which used for requesting allocation of the IP address and comprises identifier information of the terminal to an access gateway (AGW) of the WLAN network;
receiving, by the terminal, a DHCP Offer message having IP addresses allocable to the terminal from the AGW;
transmitting, by the terminal, a DHCP Request message requesting an IP address to the AGW; and
receiving, by the terminal, a DHCP ACK message in response to the DHCP Request message.

19. A method for allocating of an Internet Protocol (IP) address to a terminal for tightly coupled interworking between a cellular network and a wireless local area network (WLAN) network, the method comprises:
setting up, by a packet data serving network (PDSN) of the cellular network, a Generic Routing Encapsulation (GRE) tunnel to an access gateway (AGW) of the WLAN network received a Dynamic Host Configuration Protocol (DHCP) Discover message which used for requesting allocation of the IP address and comprises identifier information of the terminal from the terminal;
receiving, by the PDSN, the DHCP Discover message to the PDSN through the GRE tunnel from the AGW;
transmitting, by the PDSN, a DHCP Offer message having IP addresses allocable to the terminal to the AGW;
receiving, by the PDSN, a DHCP Request message having an IP address requested by the terminal from the terminal to the PDSN through the GRE tunnel from the AGW; and
transmitting, by the PDSN, a DHCP ACK message in response to the DHCP Request message to the AGW.
